(19) United States
(12) Patent Application Publication
(10) Pub. No.: US 2013/0216650 A1
(43) Pub. Date: Aug. 22, 2013

(54) STEAMER DEVICE AND METHOD OF USE THEREOF

(71) Applicant: Yoed Anis, Austin, TX (US)

(72) Inventor: Yoed Anis, Austin, TX (US)

(73) Assignee: Texas Sake Co., Austin, TX (US)

(21) Appl. No.: 13/773,965

(22) Filed: Feb. 22, 2013

Related U.S. Application Data
(60) Provisional application No. 61/601,858, filed on Feb. 22, 2012.

(51) Int. Cl. A47J 27/04

(52) U.S. Cl. CPC A47J 27/04
USPC 426/11; 426/510; 426/233; 99/410; 99/330

(57) ABSTRACT

A steamer device and method of use thereof. More particularly, a steamer device (generally a vertical steam device) designed to make loading and unloading of rice, easy, quick, and efficient while ensuring a quality steam for the rice, similar to traditional saké steaming methods.

### CROSS-REFERENCE TO RELATED PATENT APPLICATIONS

This application claims priority to provisional U.S. patent application Ser. No. 61/601,858, filed on Feb. 22, 2012, entitled “Steamer Device and Method of Use Thereof,” which provisional patent application is commonly owned by the Applicant of the present invention and is hereby incorporated herein by reference in its entirety for all purposes.

### TECHNICAL FIELD

The present invention relates to a steamer device and method of use thereof. More particularly, the present invention relates to a steamer device (generally a vertical steamer device) designed to make loading and unloading of rice, easy, quick, and efficient while ensuring a quality steam for the rice, similar to traditional saké steaming methods.

### BACKGROUND

Saké is a rice-based alcoholic beverage of Japanese origin. FIG. 1 is a flowchart that illustrates a general process by which saké is brewed.

Referring to FIG. 1, in step 101, saké rice is milled, or polished, to prepare it for brewing. Such milling must be done gently so as to not generate too much heat (which adversely affects water absorption) or not crack the rice kernels (which is not good for the fermentation process). The amount of milling greatly influences the taste of the saké.

In step 102, white powder (called nuka) left on the rice after polishing is washed away. Following that, the rice is soaked to attain a certain water content deemed optimum for steaming that particular rice. The degree to which the rice has been milled in step 101 impacts what its pre-steaming water content should be. For instance, the more the rice has been polished, the faster it absorbs water and the shorter the soaking time.

In step 103, the rice is steamed. Such steaming is different from the way table rice is prepared. It is not mixed with water and brought to a boil; rather, in the industrial batch steaming processes used in the prior art, steam is brought up through the bottom of the steaming vat (traditionally called a koshiki) to work its way through the rice. This gives a firmer consistency and slightly harder outside surface and softer center. Generally, a batch of steamed rice is divided up, with some going to have koji mold sprinkled over it, and some going directly to the fermentation vat.

Alternatively, industrial continuous steaming processes are employed. For example, the rice is put on a conveyor and moved through a steam tunnel for cooking The rice is conveyed so as to successively slide through various steps, i.e., primary steaming, hot-water immersion (water absorption) and secondary steaming, whereby the rice is cooked continuously with the movement of the conveyor.

In step 104, koji mold (in the form of a dark, fine powder) is sprinkled on the steamed rice that has been cooled. It is then taken to a special room within which a higher than average humidity and temperature are maintained. Over the next 36 to 45 hours or so, the developing koji is checked, mixed, and re-arranged constantly. The final product looks like rice grains with a slight frosting on them, and often has a faint sweet smell, such as smelling faintly of sweet chestnuts. Koji is used at least four times throughout the saké brewing process, and koji is generally made fresh and used immediately. Therefore, a batch of rice can go through step 104 at least four times.

In step 105, a yeast starter, or seed mash of sorts, is created. This is done by mixing finished koji and plain steamed white rice from steps 103 and 104, water and a concentration of pure yeast cells. For instance, in a two week period or so, a concentration of yeast cells can be developed that reaches 100 million cells in one teaspoon.

In step 106, the batch is moved to a larger tank, where more rice, more koji, and more water are added in three successive stages (typically over four days or so), which roughly doubles the size of the batch each time. This is the main mash, and as it ferments (typically over the next 18 to 32 days or so), its temperature and other factors are measured and adjusted, which will affect the flavor profile.

In step 107, the saké is pressed. Through one of several methods, the white lees (called kasu) and unfermented solids are pressed away, and the clear saké runs off. This is most often done by machine. Older methods (involving putting the moromi in canvas bags and squeezing the fresh saké out, or letting the saké drip out of the bags) are still in use.

In step 108, the saké is allowed to sit (generally for a few days) to let more solids settle out. The saké is usually charcoal filtered, which adjusts flavor and color.

In step 109, the saké is pasteurized. This is generally done by heating the saké quickly by passing it through a pipe immersed in hot water. This process kills off bacteria and deactivates enzymes that would likely adverse flavor and color later on. Saké that is not pasteurized is called namazake and must be kept refrigerated.

In step 110, the saké is aged. Most saké is left to age about six months, rounding out the flavor, before shipping.

In step 111, the saké is bottled. Usually, the saké is mixed with pure water to reduce its alcohol content of the final bottled product. For instance, the rice saké can be mixed with a bit of pure water to bring the near 20 percent alcohol down to 16 percent or so, and also blended to ensure consistency. The saké is usually pasteurized a second time at this bottling step 111.

With respect to steps 109, 110, and 111, the order of these steps can be rearranged in a different sequence (for example, the saké can be pasteurized after aging). Moreover, these steps can be performed in any sequence and repeated (for example, the saké can be pasteurized, aged, bottled, and pasteurized again).

Qualities generally required for the rice for saké brewing are well-filled kernels of large and uniform size, a low checked kernel content, a low protein content, a high rate of soaking, the development of resilience upon steaming, a high rate of mycelial growth of koji mold within the kernel, and a high susceptibility to saccharification. The rice which meets such requirements is suitable for saké brewing and is differentiated from other varieties of rice. When saké is brewed from such a suitable rice variety, the brewing process is easily controlled, the percentage recovery of saké cake is low, and a high-quality saké is produced.

Thus, the process by which the rice is steamed greatly influences the resulting quality of the saké. Accordingly, there is a need for an improved process to steam rice in a batch industrial process.

### SUMMARY OF THE INVENTION

The embodiments of the subject invention are steamer devices and methods of use thereof. Embodiments of the subject invention relate to a steamer device (generally a vertical steamer device) designed to make loading and unloading of rice, easy, quick, and efficient while ensuring a quality steam for the rice, similar to traditional saké steaming methods.

In general, in one aspect, the invention features a steaming device for steaming rice. The steaming device includes a plurality of perforated pan trays having perforations. The perforated pan trays are operable for holding rice. The perforations of the perforated pan trays are operable to allow steam to flow through the perforations such that the steam can penetrate the rice operatively held upon the perforated trays. The steaming device further includes a pan cart for receiving the perforated pan trays. The perforated pan trays are spaced apart from one another to allow steam to flow between the perforated pan trays. The steaming device further includes a chamber for receiving the pan cart and the perforated pan trays. The chamber has a sealable door through which the pan cart can be introduced into the chamber. The steaming device further includes a steam generator operatively connected to the chamber such that steam from the steam generator is capable of flowing to the interior of the chamber. The steaming device further includes a controller operatively connected to the steam generator. The controller is operable for controlling the steam introduced into the steam chamber.

Implementations of the invention can include one or more of the following features:

The pan cart can be a mobile pan cart.

The mobile pan cart can have wheels.

The mobile pan cart can be rolled into the chamber through the sealable door.

The chamber can have a second sealable door. The mobile pan cart can be rolled out of the chamber through the second sealable door.

The sealable door can have a latch. The sealable door can be capable of being sealed with the latch.

The chamber can have a ceiling that is domed or triangular in shape.

The chamber can have walls and a ceiling. The walls and the ceiling can include an insulation material. The walls and the ceiling can be coated with a water-proof coating material on the inside of the chamber.

The steaming device can further include a first steamhead located inside the chamber. The first steamhead can be operatively connected to the steam generator such that steam from the steam generator is capable of flowing to the interior of the chamber through the first steamhead.

The steaming device can further include a second steamhead located inside the chamber at a different position than the first steamhead. The second steamhead can be operatively connected to the steam generator such that steam from the steam generator is capable of flowing to the interior of the chamber through the second steamhead.

The controller can be operable for flowing steam through the first steamhead at a first set of conditions and can be further operable for flowing steam through the second steamhead at a second set of conditions.

The first set of conditions can be pressure, temperature, humidity, flow rate, or a combination thereof. The second set of conditions can be pressure, temperature, humidity, flow rate, or a combination thereof.

The controller can be a control panel.

The steaming device can further include sensors positioned within the chamber operatively connected to the controller and a computer operatively connected to the sensors and the controller.

The sensors can be operable for sensing a condition of pressure, temperature, humidity, flow rate, weight of the rice, and a combination thereof. The sensors can be operable for sending signals of the condition to the computer. The computer can be operable for sending a controller signal to the controller in response to the signals received from the sensors. The controller can be operable for adjusting the steam in response to the signal received from the computer.

The controller can be operable to change the steam being introduced into the chamber in response to the condition sensed by the sensors.

The perforated pan trays can be spaced apart from one another between about 0.3 inches to about 1 inch.

The steaming device can further include rice nets. The rice nets can be placed upon the perforated pan trays operable for holding rice.

In general, in another aspect, the invention features a method of steaming rice. The method includes preparing the rice for steaming. The method further includes placing the rice on a plurality of perforated pan trays. The perforated pan trays have perforations. The method further includes placing the plurality of perforated pan trays on a pan cart. The method further includes positioning the pan cart inside a chamber. The method further includes sealing the chamber. The method further includes flowing steam into the sealed chamber. The steam flows between the perforated pan trays and flows through the perforations of the perforated pan trays. The method further includes utilizing a controller to control the steam flowing into the sealed chamber.

Implementations of the invention can include one or more of the following features:

The step of preparing the rice can include milling the rice.

The step of preparing the rice can include washing the rice.

The pan cart can be a mobile pan cart. The step of positioning the pan cart can include moving the pan cart into the chamber.

The mobile pan cart can have wheels.

The step of moving the pan cart can include rolling the pan cart into the chamber through a sealable door.

The step of sealing the chamber can include latching closed the sealable door.

The chamber can have a ceiling that is domed or triangular in shape.

The chamber can have walls and a ceiling. The walls and the ceiling can include an insulation material. The walls and the ceiling can be coated with a water-proof coating material on the inside of the chamber.

The step of flowing steam can include flowing steam into the chamber through a first steamhead located inside the chamber.

The step of flowing steam can further include flowing steam into the chamber through a second steamhead located inside the chamber.

The controller can be utilized to control the flow of steam through the first steamhead at a first set of conditions. The controller can further be utilized to control the flow of steam through the second steamhead at a second set of conditions.

The first set of conditions can be pressure, temperature, humidity, flow rate, or a combination thereof. The second set of conditions can be pressure, temperature, humidity, flow rate, or a combination thereof.

The controller can be a control panel.

The method can further include utilizing sensors for sensing a condition of pressure, temperature, humidity, flow rate, weight of the rice, or a combination. The sensors can be positioned within the chamber. The method can further include sending signals of the condition sensed by the sensor to a computer. The method can further include sending a controller signal from the computer to the controller in response to the signals received by the computer from the sensors. The method can further include utilizing the controller to adjust the steam in response to the signal received from the computer.

The controller can change the steam being introduced into the chamber in response to the condition sensed by the sensors.

The step of placing the plurality of perforated trays on the tray cart can include spacing the pan trays apart from one another between about 0.3 inches to about 1 inch.

The method can further include placing rice nets upon the plurality of the perforated pan trays before the step of placing the rice on the plurality of perforated pan tray. The step of placing the rice on the plurality of perforated pan trays can include placing the rice on the rice nets placed upon the plurality of the perforated rice trays.

The method can further include weighing the rice before placing the rice on the plurality of perforated pan trays. The step of positioning the pan trays on the pan cart can include positioning the pan trays on the pan cart based upon the weight of the rice on the pan trays.

The pan cart can have an upper section, a middle section, and a lower section for placing the plurality of perforated pan trays on the pan cart. The step of placing the plurality of pan trays on the pan cart can include positioning the pan trays with more rice in the middle section of the pan cart and positioning the pan trays with less rice in the upper section and the lower section of the pan cart.

Each of the perforated pan trays in the middle section of the pan cart can have 50% more rice by weight place upon them than each of the perforated pan trays in the upper section and lower section of the pan cart.

In general, in another aspect, the invention features a method of making saké. The method of making saké includes preparing rice for steaming. The method of making saké further includes steaming the rice to form steamed rice. The process for steaming the rice includes spreading the rice on a plurality of perforated pan trays. The perforated pan trays have perforations. The process for steaming the rice includes placing the plurality of perforated pan trays on a pan cart. The process for steaming the rice includes positioning the pan cart inside a chamber. The process for steaming the rice includes sealing the chamber. The process for steaming the rice includes flowing steam into the sealed chamber. The steam flows between the perforated pan trays and flows through the perforations of the perforated pan trays. The process for steaming the rice includes utilizing a controller to control the steam flowing into the sealed chamber. The method of making saké further includes brewing the saké utilizing the steamed rice.

Implementations of the invention can include one or more of the following features:

The step of preparing the rice for steaming can include milling the rice. The step of preparing the rice for steaming can further include washing the rice to remove at least some white powder left on the rice after milling. The step of preparing the rice for steaming can further include soaking the rice to prepare the rice for the steaming process.

The step of brewing can include taking a first portion of the steamed rice and, after cooling the steamed rice, adding koji mold to the steamed rice. The step of brewing can further include maintaining the steamed rice and koji mold mixture in a humid and temperature controlled environment to develop koji. The steamed rice and koji mold mixture can be periodically re-mixed during this step of maintaining The step of brewing can further include forming a yeast starter. A portion of the koji, a second portion of the steamed rice, water, and pure yeast cells can be mixed when forming the yeast starter. The step of brewing can further include moving the yeast starter to a tank in which additional steamed rice, koji, and water can be added to the tank to form the main mash. The step of brewing can further include fermenting the main mash to form the saké. The step of brewing can further include pressing the main mash to remove unfermented solids from the saké.

The step of adding koji mold to the steamed rice can include sprinkling koji mold on the steamed rice.

The steamed rice and koji mold mixture can be maintained between 36 and 45 hours to develop the koji.

The step of forming the yeast starter can take at least two weeks.

The yeast starter can form has at least 100 million yeast cells per teaspoon of the yeast starter.

The main mash can be formed in multiple stages of addition. Each of the multiple stages can include adding additional steamed rice, koji, and water to the tank. There can be at least three multiple stages. The volume of the main mash can double during the addition of additional rice, koji, and water in each of the multiple stages.

The step of fermentation can take between 18 and 32 days.

The method of making saké can further include monitoring the temperature during the step of fermentation.

The method of making saké can further include allowing solids to settle in the saké after the step of pressing the main mash. The method of making saké can further include removing the settled solids from the saké.

The step of allowing the saké to settle can be for at least two days.

The method of making saké can further include pasteurizing the saké, aging the saké, bottling the saké, or a combination thereof.

The method of making saké can further include pasteurizing the saké.

The method of making saké can further include aging the saké.

The step of aging the saké can be at least for six months.

After the step of pressing, the saké can have at an alcohol content of least 20 percent.

The method of making saké can further include bottling the saké.

Water can be mixed to the saké before or during the step of bottling to reduce the alcohol content of the bottled saké. The bottled saké can have an alcohol content of around 16 percent alcohol.

The saké can be pasteurized during the bottling step.

The step of step of pasteurizing the saké in the bottling step can be at least the second time the saké has been pasteurized during the method of making the saké.

The pan cart can be a mobile pan cart. The step of positioning the pan cart can include moving the pan cart into the chamber through a sealable door. The step of sealing the chamber can include latching closed the sealable door.

The step of flowing steam can include flowing steam into the chamber through a first steamhead located inside the chamber.

The step of flowing steam can further include flowing steam into the chamber through a second steamhead located inside the chamber. The controller can be utilized to control the flow of steam through the first steamhead at a first set of conditions. The controller can further be utilized to control the flow of steam through the second steamhead at a second set of conditions, The first set of conditions can be pressure, temperature, humidity, flow rate, or a combination thereof. The second set of conditions can be pressure, temperature, humidity, flow rate, or a combination thereof.

The method can further include utilizing sensors for sensing a condition of pressure, temperature, humidity, flow rate, weight of the rice, or a combination. The sensors can be positioned within the chamber. The method can further include sending signals of the condition sensed by the sensor to a computer. The method can further include sending a controller signal from the computer to the controller in response to the signals received by the computer from the sensors. The method can further include utilizing the controller to adjust the steam in response to the signal received from the computer.

The step of placing the plurality of perforated trays on the tray cart can include spacing the pan trays apart from one another between about 0.3 inches to about 1 inch.

The method can further include placing rice nets upon the plurality of the perforated pan trays before the step of placing the rice on the plurality of perforated pan tray. The step of placing the rice on the plurality of perforated pan trays can include placing the rice on the rice nets placed upon the plurality of the perforated rice trays.

### DESCRIPTION OF DRAWINGS

FIG. 1 is a flowchart that illustrates a general process by which saké is brewed.

FIG. 2 illustrates a steamer device of the present invention and how it is used during the steaming process.

FIG. 3 depicts various layers of the steam chamber walls for an embodiment of the present invention.

FIG. 4 illustrates a pan tray that can be used to hold the rice during a steaming process utilizing the steaming device.

### DETAILED DESCRIPTION

The present invention is a steamer device and method of use, such as one that can be used to brew saké. Generally, the steamer device is vertical. The present invention is directed to industrial batch processes for steaming, as compared to industrial continuous processes used for steaming.

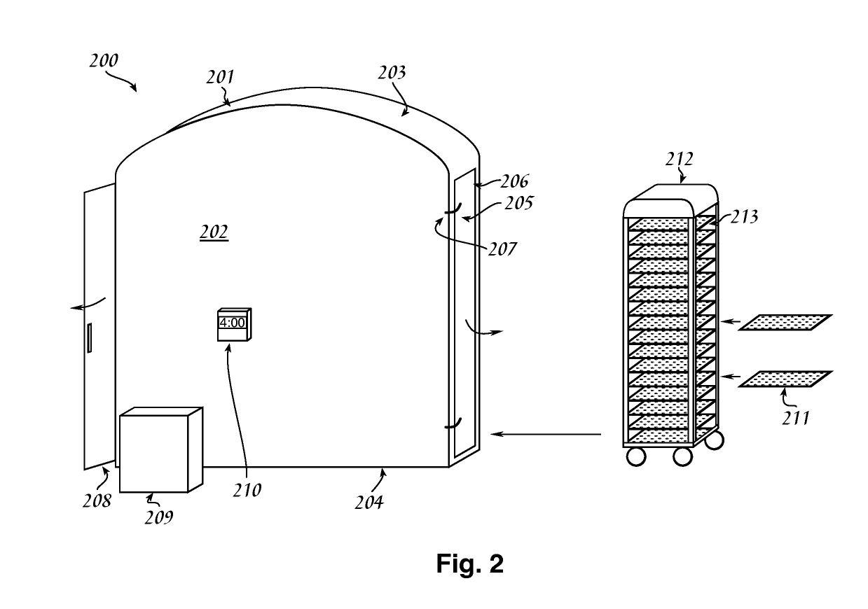

In embodiments of the present invention, the steamer device 200 includes a food-grade steam chamber 201 (such as shown in FIG. 2). As shown in FIG. 2, steam chamber 201 has walls 202, a ceiling 203, and a base 204. The steam chamber 201 also has a first door 205 that makes up some or all of one of the walls 202. The first door 205 is connected to the chamber 201 such that it can be opened for entering and exiting. For instance, the door 205 can have hinges 206 and latches 207. The latches 207 can be used to secure the door 205 in place when the steam chamber 201 is in use.

Optionally, the steam chamber 201 can include a second door 208, such as shown in FIG. 2, in a different wall 202 of the steam chamber 201. Like the first door 205, hinges and latches can be used for opening and securing the door. Furthermore, when a second door 2008 is utilized, it is preferred that the first door 205 and the second door 2008 be located on opposing walls 202 of the steam chamber 201.

The steam device 200 further includes a steam generator 209 for generating steam that is introduced into the steam chamber 201, such as through conduits (not shown) that are operatively connected to the steam generator 209 and the interior of the steam chamber 201. Generally, the steam generator 209 provides the necessary amount of steam via either a centrally located steamhead (not shown) near the base 204 of the inside of the steam chamber 201 or with several steam heads (not shown) placed throughout to ensure consistent steam dispersal within the steam chamber 201. Such steam generator can be a commercial steam generator for use to provide steam in saunas, such as the McCoy Commercial Steam Generator (McCoy Sauna And Steam, Cokato, Minn.).

The steam device 200 further includes a controller 210 (such as a control panel) that is operatively connected to the steam generator 209, for controlling the steam that is introduced in the steam chamber 201. Such controllers are available from McCoy Sauna And Steam (Cokato, Minn.). In embodiments of the present invention, the controller 210 is operatively connected to sensors (not shown) of the steam chamber 201. These sensors can be located in some (or all) of the interior of the steam chamber 201, the steam generator 209, and the conduits that conduct the steam into, and out of, the steam chamber 201.

Using the information being monitored by the sensors, the controller 210 can be used to adjust the conditions of the steaming taking place within the interior of the steam chamber 201. A computer (having a CPU) can be operatively connected to the controller 210, such that the conditions are automatically adjusted based upon the information monitored from the sensors as well as other factors that are properly steam the materials in the steam chamber 201. For example, the computer can control the time and temperature at which the steam chamber 201 operates.

The controller 210 can also be operable for removal of the steam from the steam chamber 201, such as by allowing the steam to flow outside of the steam chamber 201 via the conduits.

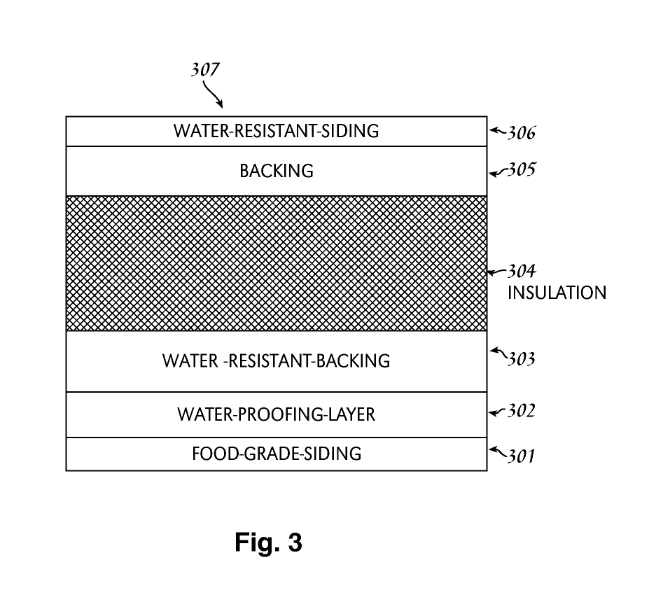

The walls 202 and of the steam chamber 201 are made of layers of various materials. FIG. 3 depicts such various layers for an embodiment of the present invention.

The interior side of the wall 202 is the side of wall 202 that is facing the interior of the steam chamber 201. As shown in FIG. 3, layer 301 is the layer that is the face of the interior side of wall 202. Layer 301 is a food grade siding on the interior. Continuing outward, layer 302 is a waterproof layer (which can be a water-proof coating). The next layer 303 is a water-resistant baseboard, which covers a thick layer 304 of insulation. On the outside of the insulating layer 304 is preferrably a backing layer 305 and a layer 306 of water-resistant siding. The exterior side 307 of wall 202 can be finished, such as by using paint and/or drywall. While the paint/drywall of exterior side 307 can be directly used to cover the insulation layer 304, it is more preferred to use the backing layer 305 and water-resistant siding layer 306 as steam can escape and condense from the steam chamber 201.

In embodiments of the present invention, the ceiling 203 is formed with the same or similar layers as used for the walls 202.

The first door 205 and second door 208 can also be made with the same or similar layers as used for the walls 202. In such case, the first door 205 and second door 208 would not be transparent (unless a window was used).

In some embodiments of the invention, a wall 202, ceiling 203, first door 205, and/or can contain a window (not shown) for viewing into the steam chamber 201. In such circumstance, the window includes a transparent material that insulates against heat transfer from the interior of the steam chamber 201. The material of the window is also capable of withstanding the interior conditions of the steam chamber 201.

In alternative embodiments of the present invention, the first door 205 and/or second door 208 (when present) can be made of such transparent and insulating materials.

The base 204 of the steam chamber 201 is a strong and waterproof surface, such as sealed-concrete, and generally has a slight angle to allow for water run-off. Entering into and exiting out of the steam chamber 201 is facilitated by first door 205 and/or second door 208 (when present). For ease of use, first door 205 and second door 208 (when present) have low or no thresholds.

In embodiments of the present invention, the ceiling 203 of the steam chamber 201 can be shaped either as a dome or triangular. Such shape reduces the incidents of water droplets falling on back down on the steamed materials (i.e., the rice). Typically, the ceiling 203 includes a controlled-vent (which is operatively connected to conduits in which the steam can leave steam chamber 201). The controlled-vent allows for the control of steam and temperature in the steam chamber by opening and closing.

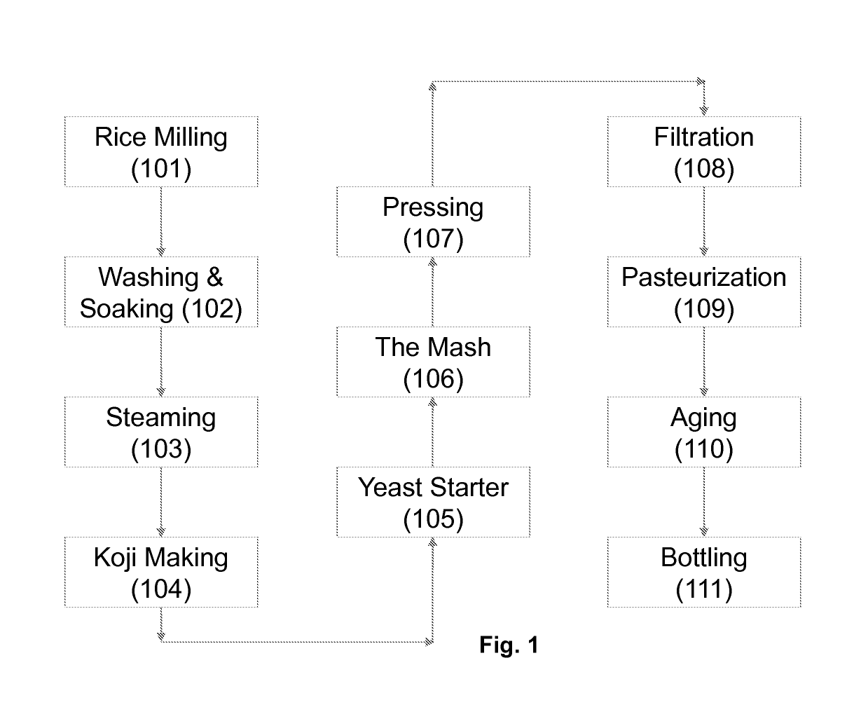

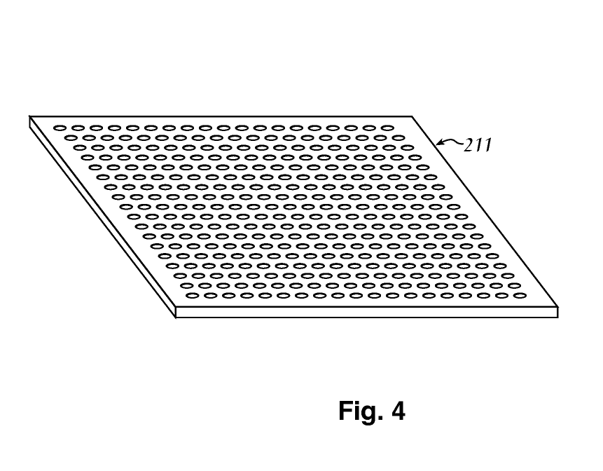

The steaming device 200 can be used as follows. After the rice is washed and soaked (in step 102 of FIG. 1), the rice is placed (i.e., packed, spread out, etc.) onto perforated pan trays operable to allow steam to penetrate to the rice. FIG. 4 illustrates a pan tray 211 that can be used to hold the rice during the steaming process. Generally, rice nets (also known as rice cooking nets) are laid across the perforated pan trays before the rice is placed onto the tray. Such rice nets can be the Korin Japanese Rice Cooking Nets (Korin Japanese Trading Corp., New York, N.Y.). Such rice nets assist in steaming process by keeping the rice from sticking to the pan trays 211, to prevent the rice from falling through the perforations of the pan trays 211, and to allow the rice to be positioned on the pan tray 211 such that steam can flow through to penetrate the rice. By such flow of steam (through the perforations of the pan trays 211 and between the pan trays This allows for a much more consistent and homogeneous steaming of the rice as compared with other batch steaming processes. (Such rice nets can be used in other steps in the process of making saké. For instance, when cooling the rice after the steaming step 103 and when performing koji making step 104, the rice nets can be placed upon a table or other flat surface before spreading out the rice.)

Once the rice is placed upon the pan trays 211, the pan trays 211 are then loaded onto a pan cart 212. The pan cart 212 has appropriate slots 213 for the trays for maximum load and for providing sufficient separation for steam to penetrate between each level of pan trays 211. In some embodiments, the pan trays 211 are located 0.3 inches to about 1 inch apart from one another on the pan cart 212.

In some embodiments, the amount of rice is distributed with more rice toward the middle levels and less rice at the top and bottom of the pan cart 212. It has been found by distributing the rice in this fashion, the steam is better able to penetrate between each level of pan trays 211 and flow through the perforations of the pan trays 211. For example, the process of loading the rice on the pan trays, includes weighing steps are utilized to weigh the rice on the pan trays 211 such that a greater weight of rice (at least about 50% greater, and typically 100% greater) is loaded on the pan trays 211 to be placed in the middle third (by height) of the pan cart 212 as compared to the weight of the rice that is packed on the pan trays 211 in the top third and bottom third of the pan cart 212. In other embodiments, the amount of the rice on the pan trays 211 is distributed in a distribution with the greatest weight of the rice in the middle portion of the pan cart 212, and a decreasing weight of rice for each subsequent pan tray 212 as they tend to the upper and lower part of the pan cart. For instance, going up from pan tray 211 that has the greatest weigh of rice, the next pan tray above it, may decrease from between 5% to 20% in weight of the rice (and generally from 5% to 10% in weight). The same may also be so for the pan trays 211 as they sequence downward from the pan tray 211 that has the greatest weight of rice.

The steam chamber 201 is designed to hold one or more pan carts 212 per steaming session.

To steam the rice, the steam generator 209 is run to increase heat and steam in the steam chamber 201 before its use. The pan carts 212 are then rolled (generally sequentially) into the steam chamber 201. When the pan carts 212 are in position, the first door 205 (and second door 208, if present) are closed and secured by latches (such as by latches 207). The steaming device 200 is then turned on and allowed to run the appropriate amount of time to ensure the correct steam and moisture content in the rice is achieved.

The sensors inside the steam chamber 201 can be setup to measure temperature, relative humidity, and the weight of the rice to help ensure a consistent steam and that the rice achieves the right moisture content. When the correct moisture is achieved, the steam generator 209 is shut-down, the first door 205 and/or second door 2008 (if present) are unlatched, and the pan carts 212 are unrolled out of the steam chamber 201. Pan trays 211 are then removed from the pan carts 212 to let the rice cool, and the rice is then ready to use in the rest of the saké brewing process, such as shown in FIG. 1.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

What is claimed is

1. A steaming device for steaming rice comprising:
(a) a plurality of perforated pan trays having perforations, wherein
(i) the perforated pan trays are operable for holding rice,
(ii) the perforations of the perforated pan trays are operable to allow steam to flow through the perforations such that the steam can penetrate the rice operatively held upon the perforated trays;
(b) a pan cart for receiving the perforated pan trays, wherein the perforated pan trays are spaced apart from one another to allow steam to flow between the perforated pan trays;
(c) a chamber for receiving the pan cart and the perforated pan trays, wherein the chamber has a sealable door through which the pan cart can be introduced into the chamber;
(d) a steam generator operatively connected to the chamber such that steam from the steam generator is capable of flowing to the interior of the chamber; and
(e) a controller operatively connected to the steam generator, wherein the controller is operable for controlling the steam introduced into the steam chamber.

2. The steaming device of claim 1, wherein the pan cart is a mobile pan cart.

3. The steaming device of claim 2, wherein the mobile pan cart can be rolled into the chamber through the sealable door.

4. The steaming device of claim 1, wherein the chamber has a second sealable door.

5. The steaming device of claim 1, wherein
(a) the chamber has walls and a ceiling;
(b) the ceiling is domed or triangular in shape;
(c) the walls and the ceiling comprise an insulation material; and
(d) the walls and the ceiling are coated with a water-proof coating material on the inside of the chamber.

6. The steaming device of claim 1 further comprising a first steamhead located inside the chamber, wherein the first steamhead is operatively connected to the steam generator such that steam from the steam generator is capable of flowing to the interior of the chamber through the first steamhead.

7. The steaming device of claim 6 further comprising a second steamhead located inside the chamber at a different position than the first steamhead, wherein
(a) the second steamhead is operatively connected to the steam generator such that steam from the steam generator is capable of flowing to the interior of the chamber through the second steamhead,
(b) the controller is operable for flowing steam through the first steamhead at a first set of conditions and is further operable for flowing steam through the second steamhead at a second set of conditions,
(c) the first set of conditions are selected from the group consisting of pressure, temperature, humidity, flow rate, and combinations thereof, and
(d) the second set of conditions are selected from the group consisting of pressure, temperature, humidity, flow rate, and combinations thereof.

8. The steaming device of claim 1 further comprising sensors positioned within the chamber operatively connected to the controller and a computer operatively connected to the sensors and the controller, wherein
(a) the sensors are operable for sensing a condition selected from the group consisting of pressure, temperature, humidity, flow rate, weight of the rice, and combinations thereof,
(b) the sensors are operable for sending signals of the condition to the computer,
(c) the computer is operable for sending a controller signal to the controller in response to the signals received from the sensors, and
(d) the controller is operable for adjusting the steam in response to the signal received from the computer.

9. The steaming device of claim 1, wherein the perforated pan trays are spaced apart from one another between about 0.3 inches to about 1 inch.

10. The steaming device of claim 1 further comprising rice nets, wherein the rice nets are placed upon the perforated pan trays operable for holding rice.

11. A method of steaming rice comprising:
(a) preparing the rice for steaming;
(b) placing the rice on a plurality of perforated pan trays, wherein the perforated pan trays have perforations;
(c) placing the plurality of perforated pan trays on a pan cart;
(d) positioning the pan cart inside a chamber;
(e) sealing the chamber;
(f) flowing steam into the sealed chamber, wherein the steam flows between the perforated pan trays and flows through the perforations of the perforated pan trays; and
(f) utilizing a controller to control the steam flowing into the sealed chamber.

12. The method of claim 11, wherein the step of preparing the rice comprises
(a) milling the rice; and
(b) washing the rice.

13. The method of claim 11, wherein
(a) the pan cart is a mobile pan cart;
(b) the step of positioning the pan cart comprises moving the pan cart into the chamber through a sealable door; and
(c) the step of sealing the chamber comprises latching closed the sealable door.

14. The method of claim 11, wherein
(a) the chamber has walls and a ceiling;
(b) the ceiling is domed or triangular in shape;
(c) the walls and the ceiling comprise an insulation material; and
(d) the walls and the ceiling are coated with a water-proof coating material on the inside of the chamber.

15. The method of claim 11, wherein the step of flowing steam comprises flowing steam into the chamber through a first steamhead located inside the chamber.

16. The method of claim 15, wherein
(a) the step of flowing steam further comprises flowing steam into the chamber through a second steamhead located inside the chamber,
(b) the controller is utilized to control the flow of steam through the first steamhead at a first set of conditions and the controller is further utilized to control the flow of steam through the second steamhead at a second set of conditions,
(c) the first set of conditions are selected from the group consisting of pressure, temperature, humidity, flow rate, and combinations thereof, and
(d) the second set of conditions are selected from the group consisting of pressure, temperature, humidity, flow rate, and combinations thereof.

17. The method of claim 11 further comprising:
(a) utilizing sensors for sensing a condition selected from the group consisting of pressure, temperature, humidity, flow rate, weight of the rice, and combinations thereof, wherein the sensors are positioned within the chamber;
(b) sending signals of the condition sensed by the sensor to a computer;
(c) sending a controller signal from the computer to the controller in response to the signals received by the computer from the sensors; and
(d) utilizing the controller to adjust the steam in response to the signal received from the computer.

18. The method of claim 11, wherein the step of placing the plurality of perforated trays on the tray cart comprises spacing the pan trays apart from one another between about 0.3 inches to about 1 inch.

19. The method of claim 11 further comprising placing rice nets upon the plurality of the perforated pan trays before the step of placing the rice on the plurality of perforated pan tray, and wherein the step of placing the rice on the plurality of perforated pan trays comprises placing the rice on the rice nets placed upon the plurality of the perforated rice trays.

20. The method of claim 11 further comprising weighing the rice before placing the rice on the plurality of perforated pan trays and, wherein the step of positioning the pan trays on the pan cart comprises positioning the pan trays on the pan cart based upon the weight of the rice on the pan trays.

21. The method of claim 11, wherein
(a) the pan cart has an upper section, a middle section, and a lower section for placing the plurality of perforated pan trays on the pan cart;
(b) the step of placing the plurality of pan trays on the pan cart comprises positioning the pan trays with more rice in the middle section of the pan cart and positioning the pan trays with less rice in the upper section and the lower section of the pan cart.

22. A method of making saké comprising:
(a) preparing rice for steaming;
(b) steaming the rice to form steamed rice, wherein the process for steaming the rice comprises:
(i) spreading the rice on a plurality of perforated pan trays, wherein the perforated pan trays have perforations;
(ii) placing the plurality of perforated pan trays on a pan cart;
(iii) positioning the pan cart inside a chamber;
(iv) sealing the chamber;
(v) flowing steam into the sealed chamber, wherein the steam flows between the perforated pan trays and flows through the perforations of the perforated pan trays; and
(v) utilizing a controller to control the steam flowing into the sealed chamber; and
(c) brewing the saké utilizing the steamed rice.

23. The method of claim 22, wherein:
(a) the step of preparing the rice for steaming comprises:
(i) milling the rice;
(ii) washing the rice to remove at least some white powder left on the rice after milling;
(iii) soaking the rice to prepare the rice for the steaming process; and
(b) the step of brewing comprises:
(i) taking a first portion of the steamed rice and, after cooling the steamed rice, adding koji mold to the steamed rice;
(ii) maintaining the steamed rice and koji mold mixture in a humid and temperature controlled environment to develop koji, wherein the steamed rice and koji mold mixture is periodically re-mixed during such step of maintaining;
(iii) forming a yeast starter, wherein a portion of the koji, a second portion of the steamed rice, water, and pure yeast cells are mixed;
(iv) moving the yeast starter to a tank in which additional steamed rice, koji, and water are added to the tank to form the main mash;
(v) fermenting the main mash to form the saké; and
(vi) pressing the main mash to remove unfermented solids from the saké.

24. The method of claim 42 further comprising a step selected from the group consisting of pasteurizing the saké, aging the saké, bottling the saké, and combinations thereof.

25. The method of claim 22, wherein
(a) the pan cart is a mobile pan cart;
(b) the step of positioning the pan cart comprises moving the pan cart into the chamber through a sealable door; and
(c) the step of sealing the chamber comprises latching closed the sealable door.

26. The method of claim 22, wherein the step of flowing steam comprises flowing steam into the chamber through a first steamhead located inside the chamber.

27. The method of claim 26, wherein
(a) the step of flowing steam further comprises flowing steam into the chamber through a second steamhead located inside the chamber,
(b) the controller is utilized to control the flow of steam through the first steamhead at a first set of conditions and the controller is further utilized to control the flow of steam through the second steamhead at a second set of conditions,
(c) the first set of conditions are selected from the group consisting of pressure, temperature, humidity, flow rate, and combinations thereof, and
(d) the second set of conditions are selected from the group consisting of pressure, temperature, humidity, flow rate, and combinations thereof.

28. The method of claim 22 further comprising:
(a) utilizing sensors for sensing a condition selected from the group consisting of pressure, temperature, humidity, flow rate, weight of the rice, and combinations thereof, wherein the sensors are positioned within the chamber;
(b) sending signals of the condition sensed by the sensor to a computer;
(c) sending a controller signal from the computer to the controller in response to the signals received by the computer from the sensors; and
(d) utilizing the controller to adjust the steam in response to the signal received from the computer.

29. The method of claim 22, wherein the step of placing the plurality of perforated trays on the tray cart comprises spacing the pan trays apart from one another between about 0.3 inches to about 1 inch.

30. The method of claim 22 further comprising placing rice nets upon the plurality of the perforated pan trays before the step of placing the rice on the plurality of perforated pan tray, and wherein the step of placing the rice on the plurality of perforated pan trays comprises placing the rice on the rice nets placed upon the plurality of the perforated rice trays.
